(19) United States
(12) Patent Application Publication
(10) Pub. No.: US 2009/0126879 A1
(43) Pub. Date: May 21, 2009

(54) WINDOW BLIND SLAT

(75) Inventor: Po-Yu CHEN, Taichung (TW)

Correspondence Address: BROWDY AND NEIMARK, P.L.L.C.;624 NINTH STREET, NW, SUITE 300, WASHINGTON, DC, 20001-5303, US

(73) Assignee: Chin-Fu CHEN, Taichung (TW)

(21) Appl. No.: 12/048,351

(22) Filed: Mar. 14, 2008

(30) Foreign Application Priority Data
Nov. 20, 2007 (TW) 96219612

(51) Int. Cl. E06B 9/24

(52) U.S. Cl. 160/236

(57) ABSTRACT

A window blind slat includes a slat substrate, a base coat coated on a surface of the slat substrate, and a metallic paint coated on a surface of the metallic paint. By means of the metallic paint, the window blind slat shows a dramatic visual effect.

### BACKGROUND OF THE INVENTION

1. Field of the Invention

The present invention relates generally to window blind slats, and more particularly, to a window blind slat having a dramatic visual effect in its appearance.

2. Description of the Related Art

To prevent the sunshine from streaming into a house, curtains made of fabric or Venetian blinds composed of slats are usually mounted to the windows of the house. Conventionally, the slats of the blinds are mostly made of aluminum alloy for enabling the window blinds to be lightweight and fireproof.

Since the slats made of aluminum look monotonous in appearance, manufactures may sometimes decorate the surfaces of the slats with a specific pattern or marking by means of a transfer paper for enhancement of visual effect of the blind slats. However, the surfaces of the slats made of aluminum tend to reflect light, thereby diluting the visual expression of the pattern or marking applied on the surfaces of the slats and further deteriorating the visual aestheticism of the slats.

### SUMMARY OF THE INVENTION

The present invention has been accomplished in view of the above-noted circumstances. Therefore, the primary objective of the present invention is to provide a window blind slat, which can provide a dramatic visual effect in its appearance.

The foregoing objective of the present invention is attained by the window blind slat composed of a slat substrate, a base coat coated on a surface of the slat substrate, and a metallic paint coated on a surface of the base coat.

By means of the metallic paint, the window blind slat can show a dramatic visual effect with sense of beauty in its appearance.

Preferably, the slat substrate may be made of, but not limited to, plastics or wood.

Preferably, a protective paint may be applied on a surface of the metallic paint to protect the metallic paint.

Preferably, the metallic paint may be, but not limited to, bronze lacquer.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a part of the window blind slat according to a preferred embodiment of the present invention, and

FIG. 2 is a sectional view taken along a line 2-2 indicated in FIG. 1.

### DETAILED DESCRIPTION OF PREFERRED EMBODIMENTS

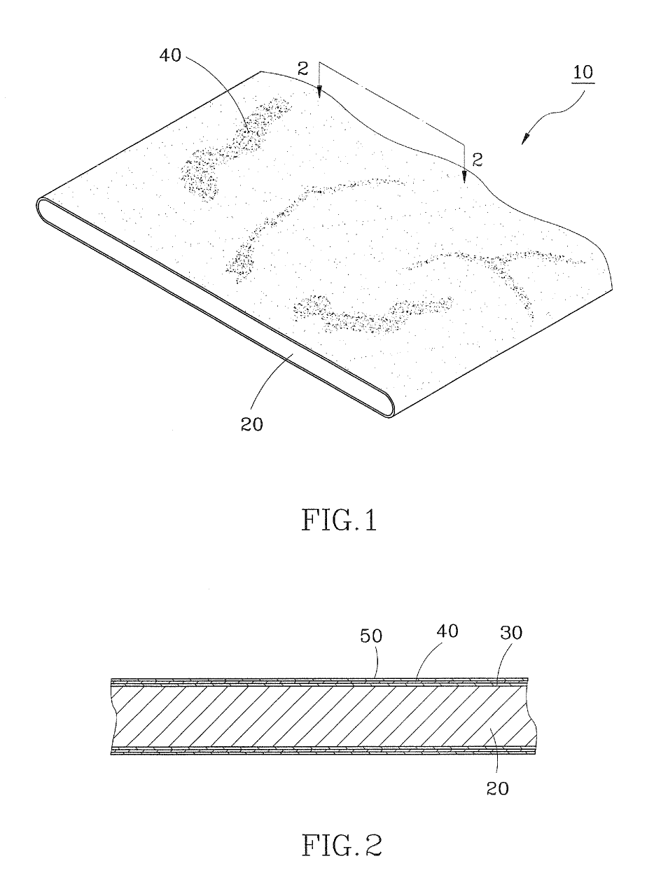

Referring to FIGS. 1-2, a window blind slat 10 in accordance with a preferred embodiment of the present invention comprises a slat substrate 20, a base coat 30, and a metallic paint 40, and a protective paint 50.

The slat substrate 20 is made of, but not limited to, plastics or wood.

The base coat 30 is coated on a surface of the slat substrate 20 by using a plurality of printing wheels (not shown). Since the painting method is a prior art, no detailed description in this regard is necessary hereinunder.

The metallic paint 40, which is, but not limited to, bronze lacquer in this embodiment, is coated on a surface of the base coat 30, and then a color shading treatment by using a plurality of print wheels with colorant is performed on a surface of the metallic paint 40, so that the surface of the slat substrate 10 shows a metalline visual effect.

The protective paint 50 is coated on the surface of the metallic paint 40 by using a plurality of printing wheels to protect the surface of the slat substrate 10 from damage possibly caused by scratch.

As stated above, because the slat substrate is coated with the metallic paint, the whole surface of the window blind slat provides a metalline visual effect but not reflects light excessively, thereby enhancing the sense of beauty and quality of the slat.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A window blind slat comprising:
a slat substrate;
a base coat coated on a surface of the slat substrate; and
a metallic paint coated on a surface of the base coat.

2. The window blind slat as defined in claim 1, wherein said slat substrate is made of plastics or wood.

3. The window blind slat as defined in claim 1, further comprising a protective paint coated on a surface of the metallic paint.

4. The window blind slat as defined in claim 1, wherein the metallic paint is bronze lacquer.
